(19) United States
(12) Patent Application Publication
(10) Pub. No.: US 2008/0009185 A1
(43) Pub. Date: Jan. 10, 2008

(54) Retrofittable radio frequency identification connector

(75) Inventors: Brent J. Knoll, Maple Grove, MN (US); Bradley A. Rohlf, Lakeville, MN (US)

Correspondence Address: IPLM GROUP, P.A., POST OFFICE BOX 18455, MINNEAPOLIS, MN, 55418, US

(73) Assignee: D B Industries, Inc.

(21) Appl. No.: 11/759,353

(22) Filed: Jun. 7, 2007

Related U.S. Application Data
(60) Provisional application No. 60/811,965, filed on Jun. 8, 2006.
(60) Provisional application No. 60/856,607, filed on Nov. 3, 2006.

(51) Int. Cl. H01R 13/40

(52) U.S. Cl. 439/595

(57) ABSTRACT

A radio frequency identification connector assembly configured and arranged for retrofittable connection comprises a device, a housing, a radio frequency identification device, and a connector. The radio frequency identification device is operatively connected to the housing, and the connector is operatively connected to the housing. The connector is configured and arranged to connect the housing to the device.

This application claims the benefit of U.S. Provisional Application Ser. No. 60/811,965, filed Jun. 8, 2006 and U.S. Provisional Application Ser. No. 60/856,607, filed Nov. 3, 2006.

### RELATED APPLICATIONS

This disclosure is related to the following co-pending applications: (1) Retrofittable Radio Frequency Identification Tag” by Brent J. Knoll et al., U.S. Provisional Application Ser. No. 60/811,965, filed Jun. 8, 2006; (2) “Radio Frequency Identification Tag” by Brent J. Knoll et al., U.S. patent application Ser. No. 29/249,952, filed Oct. 27, 2006; (3) “Retrofittable Radio Frequency Identification Connectors” by Brent J. Knoll et al., U.S. Provisional Application Ser. No. 60/856,607, filed Nov. 3, 2006; (4) “Radio Frequency Identification Connector's” by Bradley A. Rohlf, U.S. Provisional Application Ser. No. 60/856,771, filed Nov. 3, 2006; (5) “Connector for Radio Frequency Identification Device” by Bradley A. Rohlf, U.S. patent application Ser. No. 29/279,897, filed May 10, 2007; (6) “Retrofittable Radio Frequency Identification Connector” by Bradley A. Rohlf, Attorney Docket No. 221P201USU1, filed Jun. 7, 2007; (7) “Retrofittable Radio Frequency Identification Connector” by Bradley A. Rohlf, Attorney Docket No. 221P202USU1, filed Jun. 7, 2007; (8) “Retrofittable Radio Frequency Identification Connector” by Bradley A. Rohlf et al,, Attorney Docket No. 221P200US01, filed Jun. 7, 2007; (9) “Radio Frequency Identification Connector” by Bradley A. Rohlf, Attorney Docket No. 221P187USU1, filed Jun. 7, 2007; and (10) “Radio Frequency Identification Connector” by Bradley A. Rohlf, Attorney Docket No. 221P203USU1, filed Jun. 7, 2007; which are not admitted as prior art with respect to the present disclosure by its mention in this section.

### FIELD OF THE INVENTION

The present invention relates to a retrofittable radio frequency identification connector.

### BACKGROUND OF THE INVENTION

To comply with industry standards, safety devices used for fall protection and fall arrest purposes should be inspected by the user prior to each use and by a competent person other than the user at least annually. To demonstrate compliance with the industry standards, the results of the inspections should be recorded in an inspection and maintenance log for each safety device identified by the model number, the serial number, and the date manufactured or purchased. The inspection and maintenance log should also include information such as the date inspected, the inspection items noted, corrective action, maintenance performed, and the initials of the person who approved the inspection. Other information may also be included such as the dates of the next inspection and maintenance.

For example, safety harnesses commonly include labels attached to the webbing of the safety harness on which the inspection and maintenance log information may be recorded. However, these labels may become difficult to write on or read should they become soiled If a separate inspection and maintenance log is kept, it may be difficult to locate the separate log and keep it current, especially if the log is kept in a different location than the safety harness. Therefore, it is desired to provide an inspection and maintenance log that is easily accessible and convenient to use.

The present invention addresses the problems associated with the prior art devices and provides for radio frequency identification connectors for connecting radio frequency identification devices to fall protection and fall arrest safety devices for use with inspection and maintenance logs that are easily accessible and convenient to use.

### SUMMARY OF THE INVENTION

One aspect of the present invention provides an identification connector assembly configured and arranged for retrofittable connection comprising a device, a housing, an identification device operatively connected to the housing, and a connector operatively connected to the housing. The connector is configured and arranged to connect the housing to the device.

Another aspect of the present invention provides an identification connector configured and arranged for retrofittable connection to a device comprising a housing, an identification device, and a connector. The housing has a front portion and a rear portion between which is a cavity and has a top, a first side, and a second side. The identification device is within the cavity. The connector is operatively connected to the housing, and the connector is configured and arranged to connect the housing to the device.

Another aspect of the present invention provides an identification connector configured and arranged for retrofittable connection to a device comprising a housing, an identification device, and a connector strap. The identification device and the connector strap are operatively connected to the housing. The connector strap includes an intermediate portion interconnecting a first end and a second end. The intermediate portion is configured and arranged to engage the device, and the first end and the second end are connectable.

Another aspect of the present invention provides a method of retrofitting a device with an identification connector comprising operatively connecting an identification device to a housing and connecting the housing to a device.

The identification device could be connected to the housing by placing the identification device within a cavity between a front portion and a rear portion of the housing and securing the front portion and the rear portion to one another thereby securing the identification device within the cavity.

The housing could be connected to the device with an attachment strap having a first end, a second end, and an intermediate portion. The first and second ends are operatively connected to a top of the housing forming a loop proximate the intermediate portion, and the loop is configured and arranged to connect the housing to the device.

The housing could be connected to the device with a first securing strap portion operatively connected to a first side of the housing and a second securing strap portion operatively connected to a second side of the housing. The first and second securing strap portions are connectable to one another about the device to connect the housing to the device.

The housing could be connected to the device with an attachment strap and first and second securing strap portions. The attachment strap has a first end, a second end, and an intermediate portion. The first and second ends are operatively connected to a top of the housing forming a loop proximate the intermediate portion. The loop is configured and arranged to connect the housing to the device. The first securing strap portion is operatively connected to a first side of the housing and the second securing strap portion is operatively connected to a second side of the housing. The first and second securing strap portions are connectable to one another about the device to connect the housing to the device.

The housing could be connected to the device by inserting a fastener through an aperture in the housing, the fastener interconnecting the housing and the device.

### BRIEF DESCRIPTION OF THE DRAWINGS

FIG. 1 is a front view of a retrofittable radio frequency identification connector constructed according to the principles of the present invention;

FIG. 2 is a rear view of the retrofittable radio frequency identification connector shown in FIG. 1 with a cut-away portion revealing a radio frequency identification device;

FIG. 3 is a side view of the retrofittable radio frequency identification connector shown in FIG. 1;

FIG. 4 is a perspective view of a retrofittable radio frequency identification connector connected to a portion of a safety device,

FIG. 5 illustrates the retrofittable radio frequency identification connector shown in FIG. 1 connected to a safety device,

FIG. 6 is a cross-section of a fastener connecting securing straps of the retrofittable radio frequency identification connector shown in FIG. 1;

FIG. 7 is a top view of a lanyard to which another embodiment retrofittable radio frequency identification connector is operatively connected constructed according to the principles of the present invention;

FIG. 8 is a top view of the retrofittable radio frequency identification connector shown in FIG. 7; and

FIG. 9 is a side view of the retrofittable radio frequency identification connector shown in FIG. 7.

### DETAILED DESCRIPTION OF A PREFERRED EMBODIMENT

Retrofittable radio frequency identification connectors constructed according to the principles of the present invention are designated by the numeral 100 and 200 in the drawings.

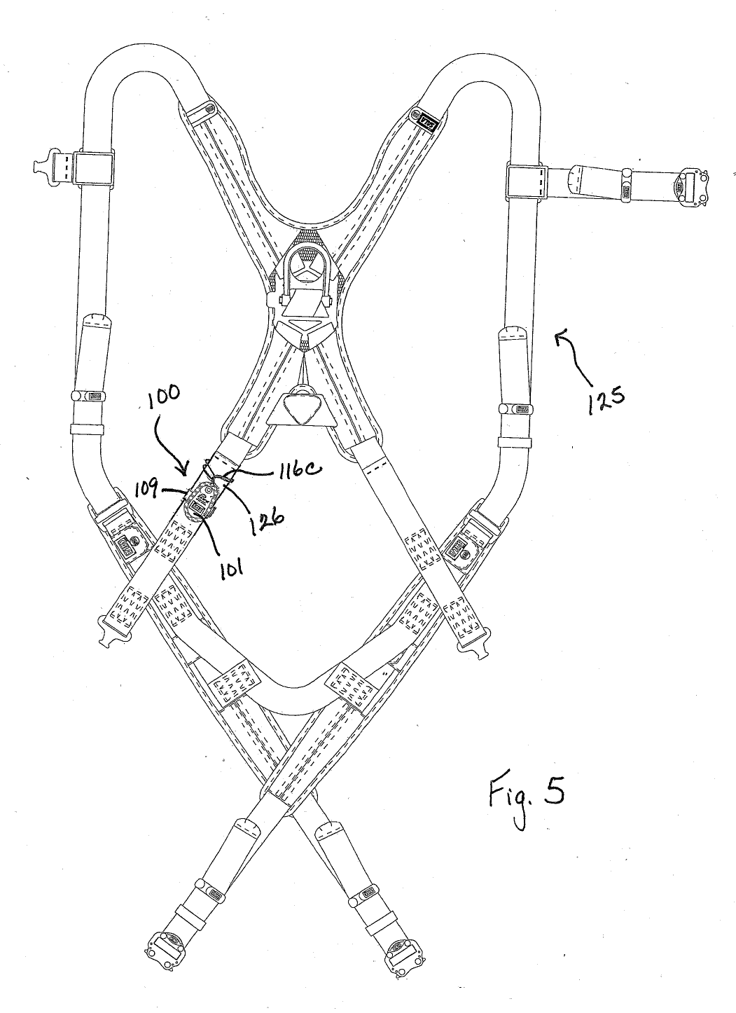

The radio frequency identification connector 100 is preferably for retrofittable connection to a completed, manufactured safety device as described herein, but it is recognized that the radio frequency identification connector 100 may also be retrofittably connected to other devices after manufacture of the devices has been completed. An example of such a safety device is a safety harness 125 having a portion of webbing 126 to which the radio frequency identification connector 100 is retrofittably connected as shown in FIG. 5. Further, although the connector 100 is preferably configured and arranged for retrofittable connection to a device, the connector 100 may be connected to a device during manufacture of the device.

An example of a suitable radio frequency identification (“RFID”) device that may be used with the embodiments of the present invention is a 134.2 kilohertz half-duplex electronic ID by Allflex USA, Inc. in Dallas Fort Worth, Tex. Another example of a suitable RFID device is disclosed in U.S. Patent Application Publication No. US 2006/0117619 A1, which is incorporated herein by reference. Although the present invention is described herein as a connector for use with a RFID device, it is recognized that the connector may also be used with other suitable identification devices such as, but not limited to, bar codes, serial numbers, and metallic codes. These identification devices may be used individually or in any combination with the connector of the present invention.

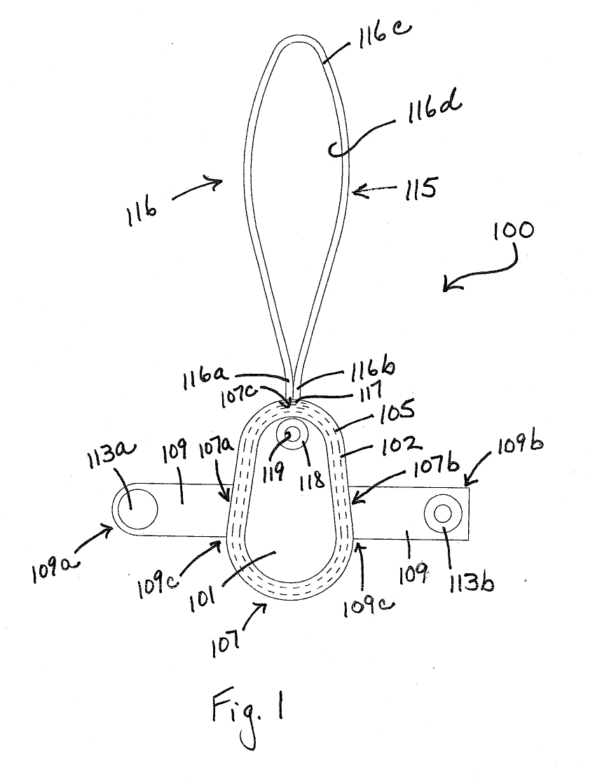

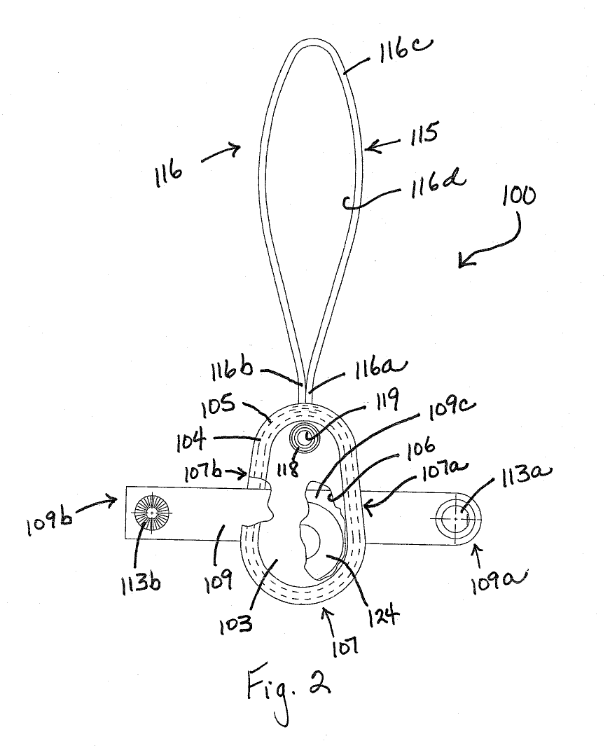

The RFID connector 100 includes a housing 107, a RFID device 124, and a connector. The housing 107 includes a front portion 101 with a binding 102 around its perimeter, as shown in FIG. 1, and a rear portion 103 with a binding 104 around its perimeter, as shown in FIG. 2. Stitching 105 interconnects the front portion 101 and the rear portion 103, between which is a cavity 106. The housing 107 also includes a first side 107a, a second side 107b, and a top 107c.

As shown in FIG. 2, the housing 107 is preferably configured and arranged to contain the RFID device 124 The RFID device 124 is positioned within the cavity 106 between the front and rear portions 101 and 103. Although the RFID device 124 is shown and described as being operatively connected to the housing 107 by being captured between the front and rear portions 101 and 103, it is recognized that the RFID device 124 may be otherwise operatively connected to the housing 107 by other suitable capturing, securing, or supporting means. For example, the RFID device could also be operatively connected to the housing by fasteners such as stitching, rivets, or cable ties.

The connector may be any one or any combination of the following connectors. One connector is an attachment strap 116 having a first end 116a, a second end 116b, and an intermediate portion 116c between the first end 116a and the second end 116b. The first end 116a and the second end 116b are preferably secured proximate the top 107c of the housing 107 within the cavity 106 between the front portion 101 and the rear portion 103 with stitching 117 thereby forming a loop 115 proximate the intermediate portion 116c with an opening 116d. The loop 115 is configured and arranged to connect the housing 107 to the safety device.

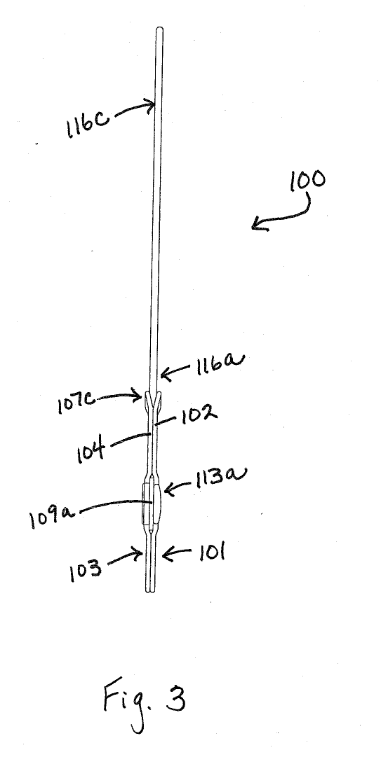

Another connector is a securing strap 109 including a first securing strap portion 109a, a second securing strap portion 109b, and an intermediate securing strap portion 109c. Preferably, the intermediate securing strap portion 109c extends through the cavity 106 between the front portion 101 and the rear portion 103 and is secured with the stitching 105. The first securing strap portion 109a extends outward from proximate the first side 107a of the housing 107, as shown in FIG. 3, and the second securing strap portion 109b extends outward from proximate the second side 107b of the housing 107. Alternatively, the first and second securing strap portions could be separate strap portions. The separate strap portions could either be similarly secured within the cavity 106 between the front portion 101 and the rear portion 103 with the stitching 105 extending outward from the sides 107a and 107b of the housing 107 or they could be secured between the binding 104 and the rear portion 103 with stitching extending inward toward one another from the sides 107a and 107b of the housing 107.

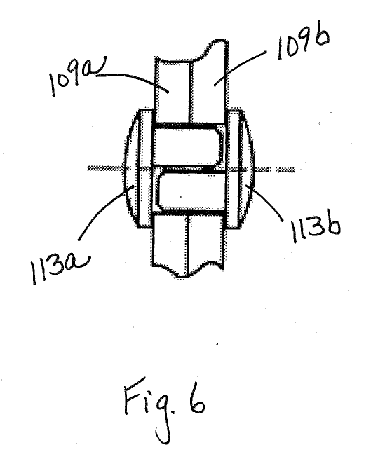

The first securing strap portion 109a and the second securing strap portion 109b are connectable to one another with a fastener 113. Preferably, the fastener 113 includes a first mating member 113a operatively connected to the first securing strap portion 109a and a second mating member 113b operatively connected to the second securing strap portion 109b. The first mating member 113 a and the second mating member 113b are preferably permanently secured to one another once connected as shown in FIG. 6. An example of a permanent fastener 113 is a ratchet rivet such as a two piece ratchet rivet, Part No. 236-170406-00, by ITW Fastex in Des Plaines, Ill. It is recognized that rivets and other types of permanent fasteners may be used. A permanent fastener is a fastener than cannot be released once connected. It is also recognized that the fastener may also be a releasable fastener so that the RFID connector 100 may be easily re-used if desired. For an easily re-usable connector, any suitable releasable fastener may be used such as a snaps, hook and loop, and buckles. If a permanent fastener is used and it is desired to re-use the connector 100, the permanent fastener can be removed and the connector 100 can be attached by other suitable connectors

Another connector is an aperture 119 in the housing 107 formed by a grommet 118. An elongate fastener, such as a cable tie (not shown), is inserted through the aperture 119, wrapped about a portion of the safety device, and secured onto itself to connect the housing to the safety device. The cable tie cannot be re-used, but the cable tie could be cut and removed and a new cable tie could be used if it is desired to re-use the RFID connector 100.

To attach the radio frequency identification connector 100 to a safety device, an appropriate location is preferably selected on the safety device where the connector 100 will not interfere with movement of the worker or the worker's tools. Examples of safety devices to which the connector 100 may be connected include safety harnesses, lanyards, self-retracting lifelines, and rescue equipment. As shown in FIG. 5, an appropriate location on a safety harness 125 is preferably a portion of webbing 126 proximate a junction where two webbing straps cross such as a shoulder strap and a leg strap proximate the worker's hip and lower back.

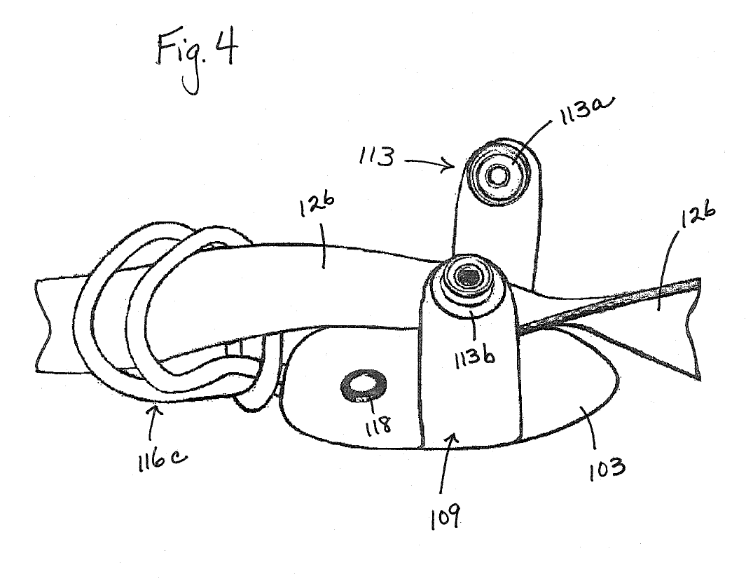

The loop 115 proximate the intermediate portion 116c of the attachment strap 116 may be used to connect the connector 100 to the safety device. The loop 115 is preferably wrapped about a portion of the safety device and then the housing 107 is inserted through the opening 116d as shown in FIG. 4. The housing 107 is preferably pulled to snug the intermediate portion 116c about the portion of the safety device, preferably choking the connector 100 onto the safety device to assist in preventing the connector 100 from moving along the length of the safety device.

The rear portion 103 of the housing 107 is then placed proximate the safety device, the first and second portions 109a and 109b of the securing strap 109 are wrapped about a portion of the safety device, and the mating members 113a and 113b are secured to one another. Preferably, the mating members 113a and 113b are permanent snaps that cannot be removed once they are secured to one another. The securing strap 109 assists in preventing the housing 107 from catching on something while the user is performing tasks or otherwise interfering with the performance of the user's tasks.

Alternatively, a cable tie can be inserted through the aperture 119 of the grommet 118, wrapped about a portion of the safety device, and secured onto itself to connect the housing 107 to the safety device. The cable tie cannot be re-used, but the cable tie could be cut and removed and a new cable tie could be used if it is desired to re-use the RFID connector 100. The cable tie assists in preventing the housing 107 from catching on something while the user is performing tasks or otherwise interfering with the performance of the user's tasks.

If a permanent fastener 113 is used and it is desired to re-use the connector 100, the securing strap 109 could be cut to remove the connector 100 from the device, and a cable tie could be used to secure the housing 107 to another device.

Any one or any combination of the connectors can be used to connect the housing 107 to the safety device. If the attachment strap 116 is used, it is preferred to also use another connector to assist in preventing the housing 107 from catching on something while the user is performing tasks or otherwise interfering with the performance of the user's tasks. If the attachment strap 116 is not used, it is recognized that either the securing strap 109 or the cable tie inserted through the aperture 119 could be used to connect the housing 107 to the safety device.

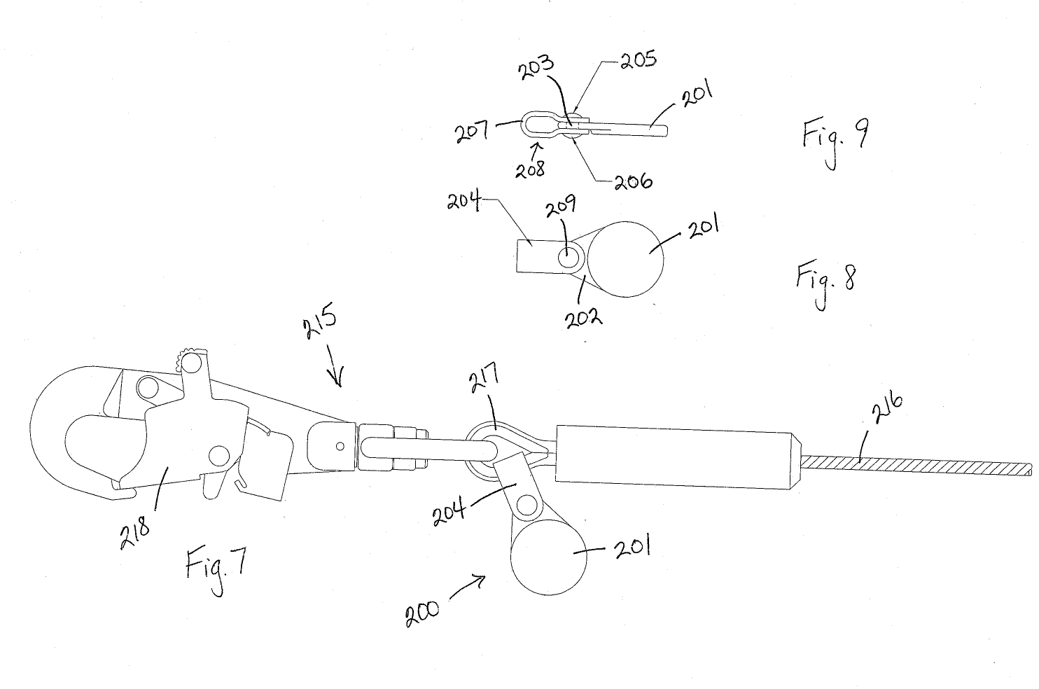

As shown in FIGS. 7-9, the RFID connector 200 includes a housing 201, which is preferably molded plastic such as urethane to accommodate an RFID device (not shown) contained therein. This is similar to how the identifying information is contained within the 134.2 kilohertz half-duplex electronic ID by Allflex USA, Inc. in Dallas Fort Worth, Tex. The housing 201 includes a flange 202 extending outward from a side of the housing 201 that includes an aperture 203. The housing 201 and the flange 202 are preferably molded as an integral piece, but it is recognized that they may be separate components operatively connected. A strap 204 includes a first end 205, a second end 206, and an intermediate portion 207 interconnecting the first end 205 and the second end 206. Each of the ends 205 and 206 includes an aperture (not shown). The strap 204 is preferably made of polyester webbing, vinyl, or any other suitable material. The flange 202 is sandwiched between the ends 205 and 206 so that the aperture 203 aligns with the apertures of the ends 205 and 206. A fastener 209 is inserted through the aligned apertures to secure the ends 205 and 206 to the flange 202.

The fastener 209 is preferably a permanent fastener. An example of a suitable permanent fastener is a ratchet rivet such as a two piece ratchet rivet, Part No. 236-170406-00, by ITW Fastex in Des Plaines, Ill. It is recognized that rivets and other types of permanent fasteners may be used. A permanent fastener is a fastener than cannot be released once connected. It is also recognized that the fastener may also be a releasable fastener so that the RFID connector 200 may be easily re-used if desired. For an easily re-usable connector, any suitable releasable fastener may be used such as a snaps, hook and loop, and buckles. If a permanent fastener is used and it is desired to re-use the connector 200, the permanent fastener can be removed and the connector 200 can be attached by other suitable fasteners.

To attach the connector 200 to a safety device, an appropriate location is preferably selected on the safety device where the connector 200 will not interfere with movement of the worker or the worker's tools. Examples of safety devices to which the connector 200 may be connected include safety harnesses, lanyards, self-retracting lifelines, and rescue equipment. As shown in FIG. 7, an appropriate location on a self-retracting lifeline 215 is preferably the looped end 217 of the cable 216 to which the hook 218 is connected as is well known in the art. One of the ends 205 and 206 is inserted through the opening in the looped end 217 of the cable 216 and then the ends 205 and 206 are brought together to form a loop 208 about the looped end 217. The flange 202 is then sandwiched between the ends 205 and 206 and the aperture 203 is aligned with the apertures of the ends 205 and 206. The fastener 209 is then inserted through the aperture 203 and the apertures of the ends 205 and 206 to secure the strap 204 to the flange 202 thus securing the RFID device to the self-retracting lifeline 215. The connector 200 may be similarly secured to other types of safety devices.

Once the connector 100 or 200 is connected to the safety device, the connector 100 or 200 can be located and the identifying information of the connector 100 or 200 can be scanned. The identifying information of the connector 100 or 200 is linked to data stored in a computer database where the inspection and maintenance log information can be entered and saved for the safety device. Examples of how this can be accomplished are disclosed in the following co-pending applications, the entire contents of which are hereby incorporated by reference in their entirety: (1) “Method of Facilitating Controlled Flow of Information for Safety Equipment Items and Database Related Thereto” by Dean R. Kaartinen et al., U.S. patent application Ser. No. 11/759,148, filed Jun. 6, 2007; (2) “Direct Data Input For Database For Safety Equipment Items and Method” by Dean R. Kaartinen et al., U.S. patent application Ser. No. 11/759,152, filed Jun. 6, 2007; (3) “Method of Retrofitting Safety Equipment Items and Database” by Dean R. Kaartinen et al., U.S. patent application Ser. No. 11/759,158, filed Jun. 6, 2007; and (4) “Centralized Database of Information Related to Inspection of Safety Equipment Items Inspection and Method” by Dean R. Kaartinen et al, U.S. patent application Ser. No. 11/759,175, filed Jun. 6, 2007. The scanning of the identifying information of the connector 100 or 200 makes recordation of the inspection and maintenance log information in the computer database easy because the connector 100 or 200 is easily accessible and convenient to use regardless if the safety device is soiled.

The above specification, examples and data provide a complete description of the manufacture and use of the composition of the invention. Since many embodiments of the invention can be made without departing from the spirit and scope of the invention, the invention resides in the claims hereinafter appended.

1. An identification connector assembly configured and arranged for retrofittable connection, comprising:
a) a device;
b) a housing;
c) an identification device operatively connected to the housing; and
d) a connector operatively connected to the housing, the connector being configured and arranged to connect the housing to the device.

2. (canceled)

3. The identification connector of claim 1, wherein the housing includes a front portion and a rear portion between which is a cavity in which the identification device is positioned, the front and rear portions assist in protecting the identification device.

4. The identification connector of claim 1, wherein the connector is an attachment strap having a first end, a second end, and an intermediate portion, the first and second ends being operatively connected to the housing forming a loop proximate the intermediate portion, the loop being configured and arranged to connect the housing to the device.

5. (canceled)

6. (canceled)

7. The identification connector of claim 1, wherein the connector is an aperture in the housing through which a fastener is inserted, the fastener being configured and arranged to connect the housing to the device.

8. The identification connector of claim 1, wherein the connector is a first securing strap portion operatively connected to a first side of the housing and a second securing strap portion operatively connected to a second side of the housing, the first and second securing strap portions being connectable to one another.

9. The identification connector of claim 8, wherein the first securing strap portion includes a first mating member and the second securing strap portion includes a second mating member, the first and second mating members being connectable to one another.

10. (canceled)

11. (canceled)

12. (canceled)

13. (canceled)

14. The identification connector of claim 1, wherein the device is a safety device selected from the group consisting of a safety harness, a lanyard, a self-retracting lifeline, and rescue equipment.

15. The identification connector of claim 1, wherein the housing is molded plastic and the identification device is molded into the housing.

16. The identification connector of claim 1, wherein the connector is a strap with an intermediate portion interconnecting a first end and a second end, the first end and the second end being operatively connected to the housing with a fastener, the intermediate portion forming a loop configured and arranged to engage the device.

17. An identification connector configured and arranged for retrofittable connection to a device, comprising:
a) a housing having a front portion and a rear portion between which is a cavity and having a top, a first side, and a second side;
b) an identification device within the cavity; and
c) a connector operatively connected to the housing, the connector being configured and arranged to connect the housing to the device.

18. The identification connector of claim 17, wherein the connector is an attachment strap having a first end, a second end, and an intermediate portion, the first and second ends being operatively connected to the top of the housing forming a loop proximate the intermediate portion, the loop being configured and arranged to connect the housing to the device.

19. The identification connector of claim 17, wherein the connector is a first securing strap portion operatively connected to the first side of the housing and a second securing strap portion operatively connected to the second side of the housing, the first and second securing strap portions being connectable to one another.

20. (canceled)

21. (canceled)

22. (canceled)

23. The identification connector of claim 17, further comprising an aperture in the housing through which a fastener is inserted, the fastener being configured and arranged to connect the housing to the device.

24. The identification connector of claim 17, wherein the connector is a strap with an intermediate portion interconnecting a first end and a second end, the first end and the second end being operatively connected to the housing with a fastener, the intermediate portion forming a loop configured and arranged to engage the device.

25. An identification connector configured and arranged for retrofittable connection to a device, comprising:
a) a housing;
b) an identification device operatively connected to the housing; and
c) a connector strap operatively connected to the housing, the connector strap including an intermediate portion interconnecting a first end and a second end, the intermediate portion configured and arranged to engage the device, the first end and the second end being connectable.

26. The identification connector of claim 25, further comprising an attachment strap having a second intermediate portion interconnecting a third end and a fourth end, the third and fourth ends being operatively connected to the housing forming a loop proximate the second intermediate portion, the loop being configured and arranged to connect the housing to the device.

27. The identification connector of claim 25, wherein the intermediate portion is operatively connected to the housing and the first and second ends connect to engage the device.

28. The identification connector of claim 25, wherein the first end and the second end are operatively connected to the housing with a fastener and the intermediate portion forms a loop configured and arranged to engage the device.

29. The identification connector of claim 25, further comprising an aperture in the housing through which a fastener is inserted, the fastener being configured and arranged to connect the housing to the device.

30. A method of retrofitting a device with an identification connector, comprising:
a) operatively connecting an identification device to a housing; and
b) connecting the housing to a device.

31. The method of claim 30, wherein the identification device is connected to the housing by placing the identification device within a cavity between a front portion and a rear portion of the housing and securing the front portion and the rear portion to one another thereby securing the identification device within the cavity.

32. The method of claim 30, wherein the housing is connected to the device with an attachment strap having a first end, a second end, and an intermediate portion, the first and second ends being operatively connected to a top of the housing forming a loop proximate the intermediate portion, the loop being configured and arranged to connect the housing to the device.

33. The method of claim 30, wherein the housing is connected to the device with a first securing strap portion operatively connected to a first side of the housing and a second securing strap portion operatively connected to a second side of the housing, the first and second securing strap portions being connectable to one another about the device to connect the housing to the device.

34. The method of claim 30, wherein the housing is connected to the device with an attachment strap and first and second securing strap portions, the attachment strap having a first end, a second end, and an intermediate portion, the first and second ends being operatively connected to a top of the housing forming a loop proximate the intermediate portion, the loop being configured and arranged to connect the housing to the device, the first securing strap portion operatively connected to a first side of the housing and the second securing strap portion operatively connected to a second side of the housing, the first and second securing strap portions being connectable to one another about the device to connect the housing to the device.

35. The method of claim 30, wherein the housing is connected to the device by inserting a fastener through an aperture in the housing, the fastener interconnecting the housing and the device.
